(19) United States
(12) Patent Application Publication
(10) Pub. No.: US 2012/0118868 A1
(43) Pub. Date: May 17, 2012

(54) CARBON NANOTUBE-METAL PARTICLE COMPLEX COMPOSITION AND HEATED STEERING WHEEL USING THE SAME

(75) Inventors: Tae-Soo Kim, Nam-gu, Ulsan (KR); Yong-Bae Jung, Chungcheongbuk-do (KR); Seong-Hoon Yue, Gyeonggi-do (KR)

(73) Assignee: LG HAUSYS, LTD., Seoul (KR)

(21) Appl. No.: 13/386,475

(22) PCT Filed: Jul. 30, 2010
(86) PCT No.: PCT/KR2010/005041

§ 371 Date: Jan. 23, 2012

(30) Foreign Application Priority Data
Aug. 20, 2009 (KR) 10-2009-0077258

(51) Int. Cl. B60L 1/02; C01B 31/00; B82B 1/00; B82Y 30/00

(52) U.S. Cl. 219/204; 423/439; 977/748; 977/902

(57) ABSTRACT

The present invention relates to a carbon nanotube-metal particle complex composition prepared by: a) a step of preparing a carbon nanotube solution in which carbon nanotubes are dispersed; b) a step of performing acid treatment on the carbon nanotube solution prepared in operation a); c) a step of neutralizing the carbon nanotube solution prepared in operation b); and d) a step of mixing the carbon nanotube solution prepared in operation c) and a metal solution containing metal particles, in order to bond said metal particles to the surfaces of said carbon nanotubes. The present invention also relates to a heated steering wheel including a carbon nanotube heating coating layer formed from the composition.

### TECHNICAL FIELD

The present invention relates to a carbon nanotube-metal particle complex composition and a heated steering wheel including a carbon nanotube heating coating layer using the same.

### BACKGROUND ART

Generally, a steering wheel of a car is mounted on a leading end of a steering shaft connected to a steering gear, so that rotation of the steering wheel is transmitted to the steering gear through the steering shaft to rotate the wheels. The steering wheel is generally made of light materials such as PVC or urethane to improve driver grip.

When a car is parked on the street for a long period of time in winter, the steering wheel is cooled by cold ambient air. Thus, when a driver grips the steering wheel, his or her hands may feel cold. Then, a heater is operated to raise temperature or a steering wheel is covered with leather or fabric to provide warming effects and to prevent the steering wheel from suffering heat loss. In the case of using the heater, a driver must wait for a long period of time until the temperature rises. In the case of using the wheel cover, warming effects are not significant. Thus, a heated steering wheels having a hot wire (heating element) therein and regulating the temperature of the steering wheel using a thermostat are disclosed in the art.

A conventional heated steering wheel has various structures. Referring to FIG. 1 showing part of a heated steering wheel, the heated steering wheel includes a core 10, a synthetic resin section 20 formed on an outer surface of the core 10, and a hot-wire pad 30 covering the synthetic resin section 20, and may further include a leather or fabric wheel cover 40 covering the hot-wire pad 30 as needed. The hot-wire pad 30 is a heating unit including a hot wire 31 (heating element) formed thereon and a thermostat 32 regulating temperature. The hot wire 31 is generally formed of a metal heating element, such as a nicrome wire, or a ceramic heating element having a positive temperature coefficient (PTC).

However, the conventional heated steering wheel employs a complicated manufacturing process, for example, processes of manufacturing a hot-wire pad and covering with the pad, and has a deteriorated sense of grip (too soft). The steering wheel to which a hot-wire pad is attached may not have a pattern transfer layer of wood or metal, since a pattern transfer layer of wood or metal cannot be formed by a hydraulic transfer process, in which a transfer film is dissolved and a pattern is transferred to an object using fluid properties of water. Further, the steering wheel necessarily includes a thermostat to regulate the temperature of the hot-wire pad.

Further, since the conventional heated steering wheel is directly gripped by the driver's hand, it is desirable that the heated steering wheel minimally include materials having a continuously changing level of resistance or a changing level of negative resistance in order to prevent a drastic increase or decrease in temperature of the steering wheel. Thus, transparent carbon nanotubes (CNTs) may be applied to the heated steering wheel as a heating element.

Here, it is important to disperse CNTs, and extensive studies are conducted to decrease contact resistance between CNTs. When contact resistance between CNTs decreases, CNTs have decreased electrical conductivity and may be used as a transparent electrode material, which is disclosed as follows.

Korean Patent Publication No. 10-2008-0112799 discloses a process of manufacturing a thin film on a plastic substrate using a CNT-metal nanoparticle mixture in order to reduce contact resistance. The mixture enables metal precursors to adhere to the surface of CNTs to decrease the total resistance of a CNT thin film. Further, the process uses a mechanism in which silver nanoparticles grow into clusters on part of the surface to which silver nanoparticles adhere through heat treatment. The CNT-metal nanoparticle mixture thus prepared may decrease a resistance level but does not allow silver nanoparticles to uniformly adhere to CNTs forming a stable wall structure, resulting in non-uniform resistance levels depending on parts.

When the CNT-metal nanoparticle mixture formed by absorption is deposited on a plastic steering wheel having a three-dimensional (3D) curved-structure to use CNTs as a heating element, it can be ascertained that the mixture does not exhibit uniform heating properties and has a changing level of resistance upon continuous turn on/off.

The heated steering wheel is directly gripped by the driver's hand, it is desirable that the heated steering wheel minimally include materials having a continuously changing level of resistance or a changing level of negative resistance in order to prevent a drastic increase or decrease in temperature of the steering wheel.

When CNTs are dispersed alone and deposited on a heated steering wheel, it is difficult to produce a desired amount of heat for the heated steering wheel due to high contact resistance. When nanoparticles are dispersed alone and deposited on a heated steering wheel, initial heating occurs due to a low resistance coefficient.

When carbon is used instead of CNTs, a resistance level considerably changes depending on temperature, which is not suitable for a heated steering wheel which requires precise temperature control.

A resistance level increases by a continual temperature increase. A continual increase in resistance reduces a flow of electric current, causing a short circuit, which can be prevented by proper use of carbon to provide complementary properties.

### DISCLOSURE

### Technical Problem

The present invention is directed to solving the problems of the related art and provides a heated steering wheel which employs a simple manufacturing process, provides an appropriate sense of grip, has a pattern transfer layer thereon, does not necessarily include a thermostat, has excellent heat transfer efficiency, and prevents concentration of heat.

Further, the present invention provides a carbon nanotube (CNT)-metal particle complex composition prepared by chemically attaching metal nanoparticles to a CNT solution to have continuous and uniform electric conductivity, and a heated steering wheel which uses the same and thus does not undergo change in resistance.

In addition, the present invention provides a heated steering wheel formed by uniformly coating a plastic wheel having a 3-dimensional (3D) structure with a first solution prepared by mixing a CNT-metal particle complex composition with a binder, thereby having heating properties within a precise temperature range and exhibiting no change in resistance according to a temperature change at 160° C. or less due to adhesive strength to a plastic wheel.

### Technical Solution

In accordance with an aspect of the present invention, a carbon nanotube (CNT)-metal particle complex composition is prepared by a method including: a) preparing a CNT solution in which CNTs are dispersed; b) treating the CNT solution prepared with an acid; c) neutralizing the CNT solution; and d) mixing the CNT solution and a metal solution containing metal particles and bonding the metal particles to surfaces of the CNTs.

In accordance with another aspect of the present invention, a heated steering wheel includes a core to maintain rigidity of the steering wheel, a synthetic resin section formed on an outer surface of the core, a CNT heating coating layer formed by coating an outer surface of the synthetic resin section with a CNT-metal particle complex composition, and an electrode electrically connected to the CNT heating coating layer to induce heat generation.

### Advantageous Effects

As such, the present invention provides a heated steering wheel, which employs a simple manufacturing process due to formation of a heating coating layer by spraying a dispersion solution, provides an appropriate sense of grip of the heating coating layer, allows a pattern transfer layer of wood or metal to be formed on the heating coating layer, does not necessarily include a thermostat, has excellent heat transfer efficiency of the heating coating layer, and prevents heat concentration.

In addition, the present invention provides a carbon nanotube (CNT)-metal particle complex composition prepared by chemically attaching metal nanoparticles to a CNT solution to have continuous and uniform electric conductivity, and a heated steering wheel which uses the same and thus does not undergo change in resistance.

Further, the present invention provides a heated steering wheel formed by uniformly coating a plastic steering wheel having a 3-dimensional (3D) structure with a first solution prepared by mixing a CNT-metal particle complex composition with a binder, thereby having heating properties within a precise temperature range and having no change in resistance according to a temperature change at 160° C. or less due to adhesive strength to a plastic wheel.

### DESCRIPTION OF DRAWINGS

FIG. 1 is a configuration view of a conventional heated steering wheel;

FIG. 2 is a top view of a heated steering wheel according to one exemplary embodiment of the present invention;

FIG. 3 is a cross-sectional view taken along line A-A of FIG. 2;

FIG. 4 is a cross-sectional view of a heated steering wheel according to another exemplary embodiment of the present invention;

FIG. 5 illustrates a process of manufacturing a heated steering wheel according to an exemplary embodiment of the present invention;

FIG. 6 is a flowchart of the process of manufacturing a heated steering wheel according to the exemplary embodiment of the present invention;

FIG. 7(a) illustrates a particle model of a general carbon nanotube (CNT) heating element;

FIG. 7(b) illustrates a particle model of a heating element formed of carbon nanotubes (CNTs) and conductive materials, such as silver (Ag) particles or metal particles;

FIG. 8(a) is an electrical network model of general carbon;

FIG. 8(b) is an electrical network model of carbon nanotubes (CNTs);

FIG. 9 illustrates a process of Example 1;

FIG. 10 is a picture of a heated steering wheel to be coated with solutions prepared in Example 1 and Comparative Examples 1 and 2;

FIG. 11 is a picture of a finished product obtained by covering the steering wheel of FIG. 10 with leather; and

FIG. 12 is a graph depicting a result of durability test of Example 1.

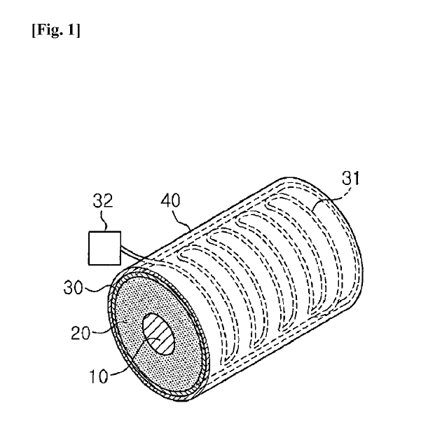

### MODE FOR INVENTION

According to the present invention, a carbon nanotube (CNT)-metal particle complex composition is prepared by a method including: a) preparing a CNT solution in which CNTs are dispersed; b) treating the CNT solution prepared with an acid; c) neutralizing the CNT solution; and d) mixing the CNT solution and a metal solution containing metal particles and bonding the metal particles to surfaces of the CNTs.

Here, the CNTs may be at least one selected from multi-wall nanotube (MWNT), thin wall nanotube (TWNT), and single wall nanotube (SWNT).

The CNT solution may be prepared by dispersing the CNTs in a solvent.

The acid treatment may be performed using at least one selected from nitric acid, sulfuric acid, hydrochloric acid, and perchloric acid.

The neutralization may be performed using at least one selected from an aqueous sodium hydroxide solution, an aqueous potassium hydroxide solution, and an aqueous ammonium hydroxide solution.

Generally, when CNTs are treated with an acid, carboxyl groups are randomly generated and pH decreases, resulting in acidification. When these CNTs are used via filtration, the CNTs undergo deterioration in electrical conductivity due to numerous defective elements in CNT molecular structures attacked by the acid. To solve this problem, in the present invention, neutralization of the CNTs is performed to adjust pH to 6 or higher, preferably 7.

When the acid-treated CNTs are used via filtration only, a trace amount of acid ions exist, causing added metal nanoparticles to be easily oxidized by remaining acid ions. In the present invention, pure metal nanoparticles are mixed with the acid-treated CNTs. Thus, if metal nanoparticles are mixed with the CNTs without consideration of pH, the metal nano particles may be oxidized by remaining acid ions by Coulomb force before physical absorption.

Thus, in the present invention, for chemically bonding metal particles to carboxyl group-introduced CNTs, neutralization is conducted to prevent metal particles from being attacked by acid ions, thereby preventing acid ions from participating in a process of stabilizing the CNTs and in a process of chemically bonding the metal particles.

The CNT solution is mixed with at least one selected from an aqueous sodium hydroxide solution, an aqueous potassium hydroxide solution, and an aqueous ammonium hydroxide solution using ultrasonication.

The metal solution containing metal particles may include a solvent; a solution obtained by mixing at least one selected from TOAB, 1,2-dichlorobenzene, N-methylpyrrolidone (NMP), and N,N-dimethylformamide (DMF) with formaldehyde or acetaldehyde; and at least one metal salt selected from Ag, Pt, Pd, Au, Cu, Ni, Al, Ag/Cu, and Ag/Ni salts.

Examples of the metal salt may include, without being limited to, AgCl, AgI, AgBr, AgNO₃, AgCN, and KAg(CN)₂. Preferably, the metal salt may be used by dissolution in an aqueous HNO₃ solution, followed by addition of a small amount of NH₃.

The metal particles bonded to the surfaces of the CNTs may include at least one selected from Ag, Pt, Pd, Au, Cu, Ni, Al, Ag/Cu, Ag/Ni, and Cu/Ni. Further, the metal particles bonded to the surfaces of the CNTs may have a diameter of 10 to 300 nm.

The method may further include preparing a dispersion solution by dispersing the solution of operation d) in at least one selected from MEK, MIBK, acetone, cyclohexanone, a ketone solution, butoxyethyl acetate, butyl carbitol acetate (BCA), and an acetate solution; and mixing the dispersion solution with a binder.

Here, the binder may be at least one selected from a polyurethane resin, a polyester resin, and an acrylic resin.

### EXAMPLE 1

2 mg of MWNT and 100 ml of distilled water were placed in a glass beaker and physically dispersed at 15,000 psi using a microfluidizer (M-110S), thereby obtaining a CNT solution. The CNT solution was ultrasonically mixed with an aqueous solution containing sulfuric acid and nitric acid at 3:1 for 1 hour using a sonicator (ULH-700).

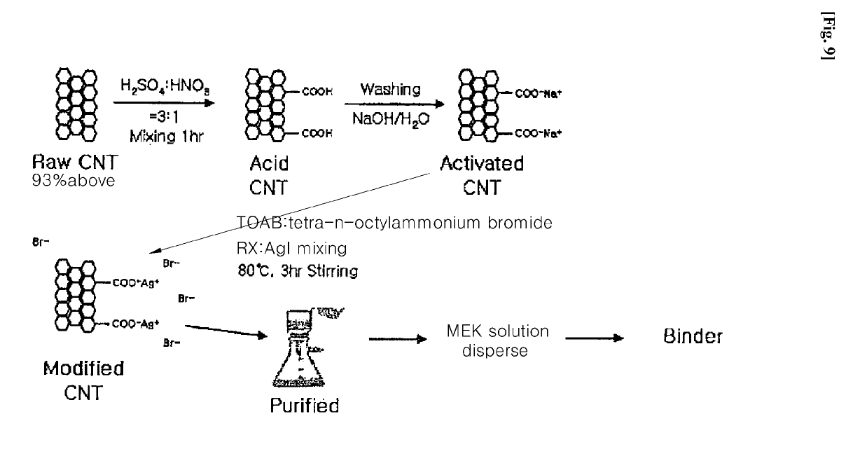

Then, the CNT solution was neutralized with a NaOH aqueous solution. An RX containing solution was prepared by mixing TOAB in aqueous DMF, 10 ml of toluene, and 1 ml of acetaldehyde, followed by addition of an aqueous nitric acid solution and 0.1 g of AgCl and slow addition of thick NH₃. Subsequently, the RX containing solution was added to the MWNT including NaOH and mixed at 80° C. for 3 hours to conduct phase transfer reaction, so that Ag particles were extracted and bonded to the surface of CNTs. The reaction solution was filtered using an aluminum membrane (anodisc, 200 nm) and a filter and then dispersed in an MEK solution, followed by addition of a binder (EXP-7, LG Chem Ltd.), thereby preparing a CNT-metal particle complex composition according to the present invention (see FIG. 9).

### COMPARATIVE EXAMPLE 1

2 mg of MWNT and 100 ml of distilled water were placed in a glass beaker and physically dispersed at 15,000 psi using a microfluidizer (M-110S), thereby obtaining a CNT solution. The CNT solution was ultrasonically mixed with 10 ml of NMP for 10 hours using an ultrasonicator (ULH-700).

The solution was filtered using an aluminum membrane (anodisc, 200 nm) and a filter, and then a silver precursor solution, prepared by mixing 5 g of silver nitrate and 4.5 ml of butyl amine with 60 ml of toluene, was filtered, thereby preparing a CNT-metal nanoparticle mixture.

The mixture was thermally treated at 120° C. or less for 2 hours and then dispersed in a MEK solution, followed by addition of a binder (EXP-7, LG Chem Ltd.), thereby preparing a CNT-metal nanoparticle mixture solution.

### COMPARATIVE EXAMPLE 2

2 mg of MWNT and 100 ml of MEK were put in a glass beaker and physically dispersed at 15,000 psi using a microfluidizer (M-110S), thereby obtaining a CNT solution. The CNT solution was mixed with a binder (EXP-7, LG Chem Ltd.), thereby preparing a solution.

### EXPERIMENT EXAMPLE 1

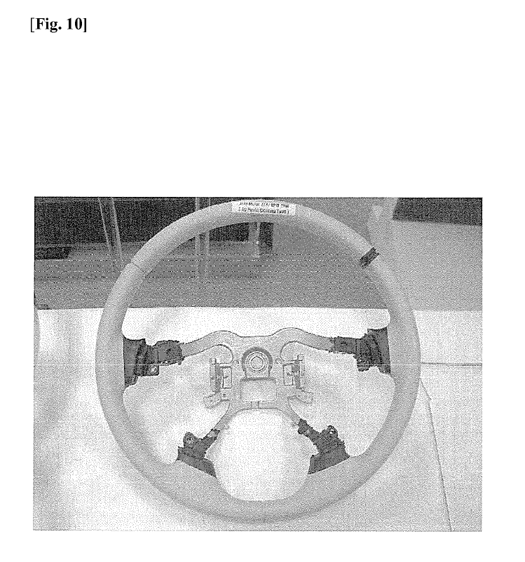

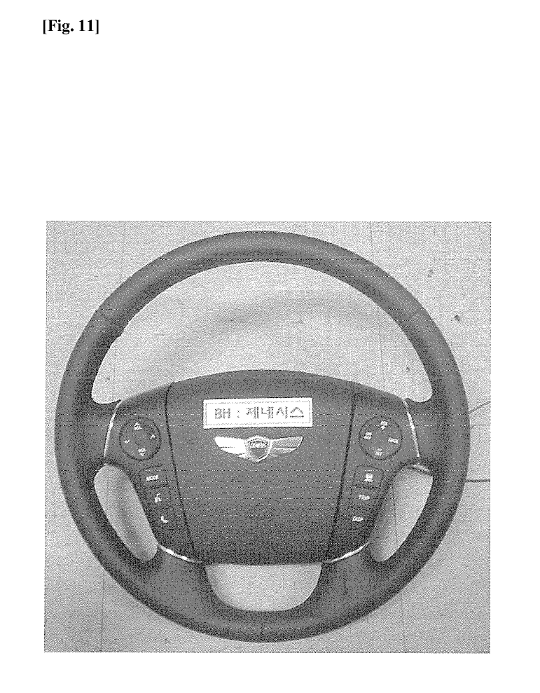

A 3D-structure plastic steering wheel (urethane) was uniformly spray-coated with each of the solutions prepared in Example 1 and Comparative Examples 1 and 2. Each wheel was dried at 100° C. or less for 2 hours in consideration of deformation temperature of the urethane wheel, followed by measurement of sheet resistance at three points of the steering wheel (see FIGS. 10 and 11) twice using a surface resistivity meter (MCP-HT450), and results are illustrated in Table 1.

TABLE 1

| | | | | | | | Average |
|---|---|---|---|---|---|---|---|
| | | | | | | | sheet |
| | First test | | | Second test | | | resistance |
| | A | B | C | A | B | C | (Ω/sq) |
| Example 1 | 15.8 | 15.7 | 15.8 | 15.9 | 15.6 | 15.8 | 14.8 |
| Comparative | 17.4 | 14.7 | 16.5 | 16.3 | 15.9 | 18.2 | 16.5 |
| Example 1 | | | | | | | |
| Comparative | 106 or | 106 or | 106 or | 106 or | 106 or | 106 or | 106 or |
| Example 2 | more | more | more | more | more | more | more |

When CNTs are used only in Comparative Example 2, the steering wheel has a high sheet resistance of 106 or higher and thus is not proper for a heating steering wheel. In the case of the CNT-metal nanoparticle mixture according to Comparative Example 1, silver (Ag) is not uniformly dispersed, and thus resistance differences are considerable among the points. That is, a CNT-metal nanoparticle complex composition has a uniform surface resistance and thus is proper for a heating element.

### EXPERIMENT EXAMPLE 2

The steering wheel manufactured using the composition according to Example 1 was covered with leather to form a finished product (see FIG. 11), which was subjected to a temperature-rise test by applying a direct current (DC) of 12 volts using an IT6720 Power Supply. The steering wheel manufactured using the mixture according to Comparative Example 1 was covered with leather to form a finished product, to which a DC voltage of 12 volts was applied using an IT6720 Power Supply. The steering wheel increased in temperature in 2 minutes, and then short circuited and failed. Further, electric current did not flow in the steering wheel manufacturing using the solution according to Comparative Example 2 at a DC voltage of 12 volts.

### EXPERIMENT EXAMPLE 3

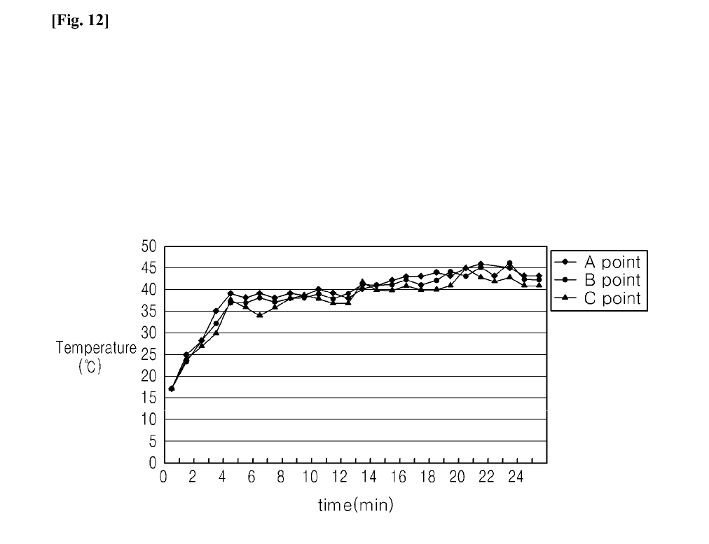

The steering wheel manufactured using the composition according to Example 1 was covered with leather to form a finished product, which was cooled in a low-temperature chamber at −20° C. for 6 hours. Then, the product was placed at a room temperature of 25° C., at which time a DC voltage of 12 volts was applied using an IT6720 Power Supply, and temperature changes on the surface of the steering wheel were measured using a thermocouple. Similarly to a durability test result in FIG. 12, temperature of the wheel increased to 25° C. or higher in 1 minute, and thus the surface of the steering wheel began to warm, and the temperature reached about 35° C. after 5 minutes. The steering wheel meets a heated steering wheel standard (E556100-05) that a heated steering wheel is required to reach 40° C. within 15 minutes. Further, as a result of a long-term stability test of the steering wheel without a PID controller which maintains a constant temperature of the wheel, the wheel was maintained at 50 to 53° C. and was not burned or deformed.

As such, according to the present invention, a CNT-metal particle complex composition may be prepared using phase transfer reaction so as to make metal nanoparticles uniformly dispersed in CNTs while preventing the metal nanoparticles from being separated from the CNTs in preparation of a dispersion solution.

In the CNT-metal particle complex composition, since specific resistance disappears due to a carbon-carbon covalent bond as a unique feature of CNTs and a flow pattern of electric current by the covalent bond, a current density of about 1,000 times higher than that of a copper wire may be obtained and contact resistance may be reduced by a charge transfer passage of metal nanoparticles bonded to the CNTs.

According to the present invention, since metal particles are uniformly dispersed in each CNT particle and strong chemical bonds are created between the metal nanoparticles and the CNTs, the CNTs and the metal nanoparticles are not separated from each other in a coating solution including a binder. Further, the CNT-metal particle complex composition uniformly applied to a 3D plastic steering wheel is securely bound thereto, thereby preventing generation of negative resistance or separation of the metal nanoparticles causing contact resistance. The CNT-metal particle complex composition is used not only to reduce electrical conductivity, but also to make it possible for the heated steering wheel to maintain a constant and uniform temperature within a required heating range.

A heated steering wheel according to the present invention includes a core to maintain rigidity of the steering wheel, a synthetic resin section formed on an outer surface of the core, a CNT heating coating layer formed by coating an outer surface of the synthetic resin section with the CNT-metal particle complex composition, and an electrode electrically connected to the CNT heating coating layer to induce heat generation.

The CNT heating coating layer is coated with the CNT-metal particle complex composition in which CNT particles and metal particles are chemically bonded to each other.

An outer surface of the CNT heating coating layer may be covered with a cover.

The cover may include any one selected from leather, fabric, and polyurethane (PU).

A transfer layer may be formed by a hydraulic transfer method on an outer surface of the CNT heating coating layer.

An external coating layer may be formed on an outer surface of the transfer layer.

Next, exemplary embodiments of the present invention will be described in detail with reference to the accompanying drawings.

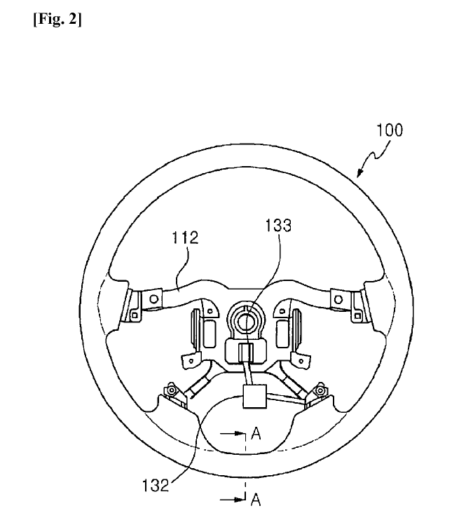

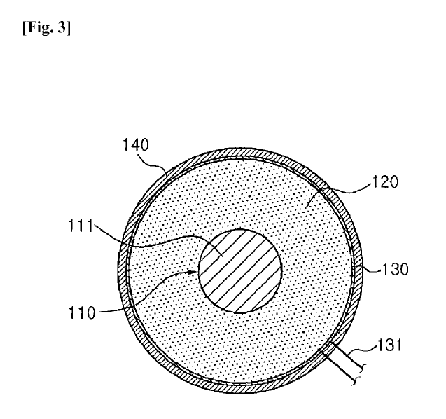

FIG. 2 is a top view of a heated steering wheel according to one exemplary embodiment of the present invention, showing that a cover is removed from a spoke, and FIG. 3 is a cross-sectional view taken along line A-A of FIG. 2. As shown in FIGS. 2 and 3, the heated steering wheel 100 according to the embodiment includes a core 110 formed of steel or a light alloy, a synthetic resin section 120 formed on an outer surface of the core 110, a CNT heating coating layer 130 formed by coating an outer surface of the synthetic resin section 120 with a CNT-metal particle complex composition, and a cover 140 formed on the CNT heating coating layer 130.

The core 110 includes a rim 111 and a spoke 112 and has various cross sections, such as a circular shape, a “ [symbol] ” shape, an “H” shape, etc.

The synthetic resin section 120 may be formed by forming PU, expanded polystyrene (EPS), or expanded polypropylene (EPP) into foam (expanded plastic) or by injection-molding synthetic resins, such as ABS, etc.

The CNT heating coating layer 130 is a layer formed by spraying a CNT-metal particle complex composition onto the synthetic resin section 120, preferably by spraying a CNT-metal particle complex composition in which metal particles, e.g., silver (Ag) particles, are chemically bonded to the CNTs.

The CNT heating coating layer 130 may have a coating mass per unit area of 3 to 15 g/m².

An electrode 131 electrically connected to the CNT heating coating layer 130 to induce heat generation is formed. A thermostat 132 may be connected to the electrode 131, as needed. However, since it is possible to control temperature based on unique properties of the CNTs (controlling electric charges), the thermostat 132 may be eliminated. When used, the thermostat 132 is connected to a power connector 133.

A CNT is an anisotropic material having a diameter and a length of several to hundreds of micrometers (μm). In a CNT, one carbon atom is bonded to three other carbon atoms to form a hexagonal honeycomb pattern. A nanotube structure is formed by drawing a honeycomb pattern on a flat sheet of paper and rolling the sheet of paper. That is, a single nanotube has a shape of a hollow tube or cylinder. A nanotube is so named because the tube generally has a small diameter of about 1 nanometer (1/1 billion meter). Since the nanotube structure is formed by drawing a honeycomb pattern on a flat sheet of paper and rolling the sheet of paper, CNTs may be formed into an electrical conductor in an armchair structure or a semiconductor in a zigzag structure according to an angle at which the sheet of paper is rolled.

The cover 140 is a finishing material of leather, fabric or PU. The leather or fabric covers the CNT heating coating layer 130 and is combined therewith by sewing, and the PU covers the CNT heating coating layer 130 and is combined therewith by coating.

General information about a heating element using CNTs is disclosed in detail in Korean Patent No. 074988, and descriptions thereof are thus omitted.

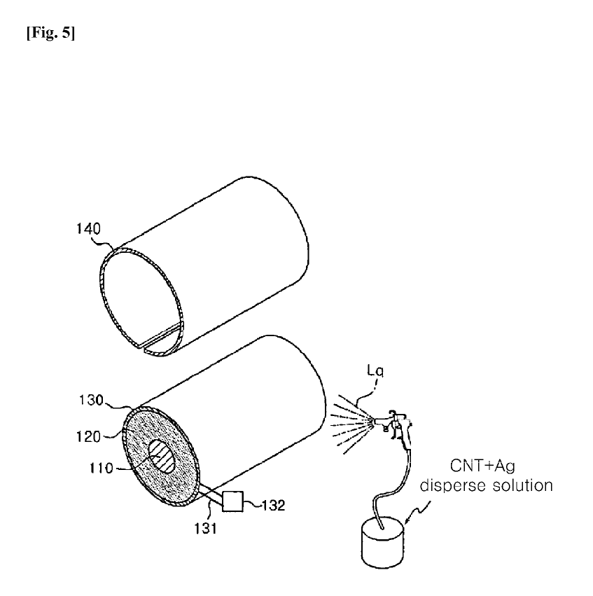

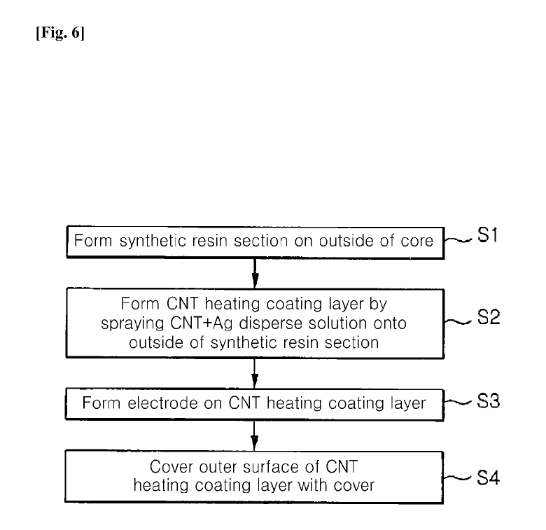

As shown in FIGS. 5 and 6, the heated steering wheel having the above configuration according to the present invention is manufactured as follows. The synthetic resin section 120 is formed on the outer surface of the core 110 in S1. Then, a dispersion solution (Lg) that is a CNT-metal particle complex composition in which metal particles are chemically boned to surfaces of CNTs is sprayed onto the outer surface of the synthetic resin section 120 to form the CNT heating coating layer 130 in S2. The electrode 131 is formed on the CNT heating coating layer 130 in S3, the thermostat 132 is installed as needed, and then the outer surface of the CNT heating coating layer 130 is covered with the cover 140, thereby completing the heated steering wheel.

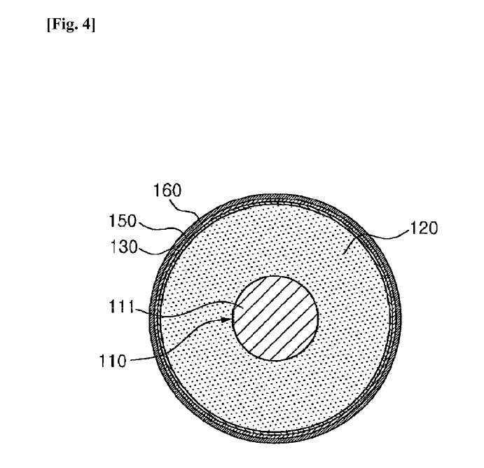

Referring to FIG. 4, a heated steering wheel according to another exemplary embodiment of the invention may include a core 110, a synthetic resin section 120 formed on an outer surface of the core 110, and a CNT heating coating layer 130 formed on an outer surface of the synthetic resin section 120. A pattern transfer layer 150 of wood or metal may be formed on an outer surface of the CNT heating coating layer 130 and an external coating layer 160 may be further formed on an outer surface of the transfer layer 150. The pattern transfer layer 150 of wood or metal may be formed by a known hydraulic transfer method, and the external coating layer 160 may be applied to the surface of the transfer layer 150 using various materials and methods known in the art.

A hot-wire heating element used for a conventional heated steering wheel allows a heated element to locally contact a heating wire, and thus heat transfer efficiency with respect to the heated element is reduced and it takes a long period of time to reach maximum temperature. However, a CNT heating element used for the heated steering wheel according to the invention allows a heated element to be entirely in contact with a heating layer, heat transfer efficiency to the heated element is excellent and it takes a short period of time to reach maximum temperature.

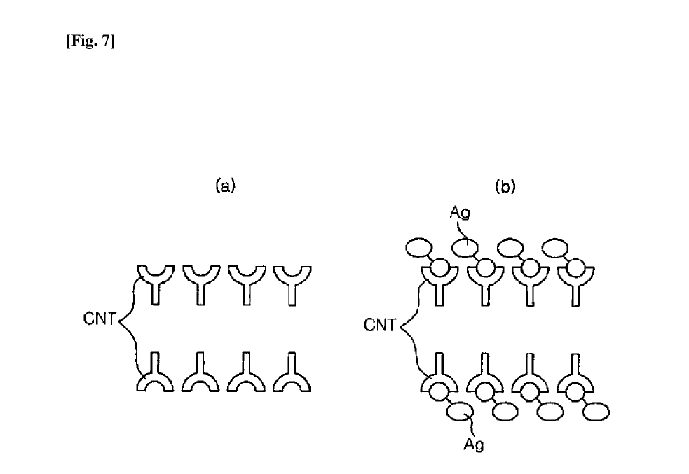

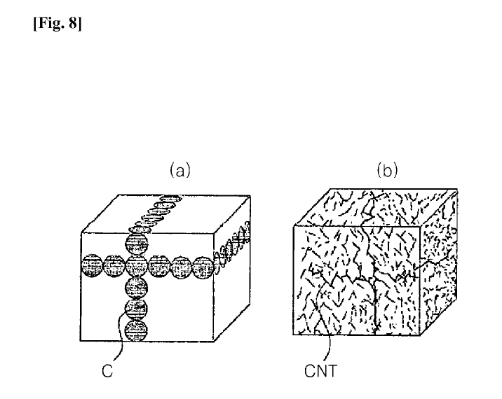

As shown in FIGS. 7(a) and 8(a), a general carbon heating element (fluorene, amorphous carbon, and graphite) has a negative temperature coefficient of resistance which is a characteristic of carbon, and thus reliability is not secured since resistance decreases through repeated use. Further, a conventional metal heating element has a positive temperature coefficient of resistance, and thus reliability is not secured since resistance increases through repeated use. On the contrary, as shown in FIGS. 7(b) and 8(b), since CNTs have a linear molecular structure instead of a spherical structure, the CNTs have fewer spots where a short circuit can occur, thereby providing stable resistance. In particular, a heating element formed of the CNT-metal particle complex composition, in which metal particles are chemically bonded to the surface of CNTs, exhibit properties of a positive temperature coefficient (PTC) to have a temperature coefficient of resistance of nearly 0 and easily secures reliability without resistance change in repeated use. Such properties are realized not only by mixing carbon having a negative temperature coefficient of resistance with a metal having a positive temperature coefficient of resistance, but also by chemically bonding conductors including metal particles to the surfaces of CNTs.

As shown in an electrical network model of general carbon of FIG. 8(a), general carbon particles are brought into contact with each other and thus allow conduction of electricity therethrough. During coating, carbon particles may be agglomerated at a particular spot. In this case, heat may be generated focused at the spot. However, as shown in an electrical network model of CNTs of FIG. 8(b), even though CNT particles are separated a distance from each other instead of adjoining each other, an electrical network is established to allow conduction of electricity therethrough. Therefore, CNTs provide equivalent or greater performance with a considerably small amount as compared with general carbon, thereby excluding a possibility of agglomeration of CNT particles in a particular spot, thereby ensuring uniform heat distribution without heat concentration.

As described above, the heated steering wheel according to the embodiments of the invention employs a process of spraying CNTs and conductors including metal particles, instead of a process of attaching a hot-wire pad used in fabrication of a conventional heated steering wheel, thereby remarkably reducing manufacturing costs. Further, the heated steering wheel according to the embodiments of the invention may allow a pattern transfer layer of wood or metal to be formed therein, have a proper sense of grip and various shapes and resistance designs, and considerably save energy as compared with steering wheel in the art. Further, the heated steering wheel according to the embodiments of the present invention may not need a thermostat due to properties of CNTs (controlling electric charges).

1. A carbon nanotube (CNT)-metal particle complex composition prepared by a method comprising:
a) preparing a CNT solution in which CNTs are dispersed;
b) treating the CNT solution with an acid;
c) neutralizing the CNT solution; and
d) mixing the CNT solution and a metal solution containing metal particles and bonding the metal particles to surfaces of the CNTs.

2. The CNT-metal particle complex composition of claim 1, wherein the CNTs comprises at least one selected from multi wall nanotube (MWNT), thin wall nanotube (TWNT), and single wall nanotube (SWNT).

3. The CNT-metal particle complex composition of claim 1, wherein the CNT solution is prepared by dispersing the CNTs in a solvent.

4. The CNT-metal particle complex composition of claim 1, wherein the acid treatment is performed using at least one selected from nitric acid, sulfuric acid, hydrochloric acid, and perchloric acid.

5. The CNT-metal particle complex composition of claim 1, wherein the neutralization is performed using at least one selected from an aqueous sodium hydroxide solution, an aqueous potassium hydroxide solution, and an ammonium hydroxide aqueous solution.

6. The CNT-metal particle complex composition of claim 5, wherein the neutralization is performed by mixing the acid-treated CNT solution with at least one selected from an aqueous sodium hydroxide solution, an aqueous potassium hydroxide solution, and an aqueous ammonium hydroxide solution using ultrasonication.

7. The CNT-metal particle complex composition of claim 1, wherein the metal solution containing metal particles comprises a solvent; a solution obtained by mixing at least one selected from TOAB, 1,2-dichlorobenzene, N-methylpyrrolidone (NMP), and N,N-dimethylformamide (DMF) with formaldehyde or acetaldehyde; and at least one metal salt selected from Ag, Pt, Pd, Au, Cu, Ni, Al, Ag/Cu, and Ag/Ni salts.

8. The CNT-metal particle complex composition of claim 1, wherein the metal particles bonded to the surfaces of the CNTs comprise at least one selected from Ag, Pt, Pd, Au, Cu, Ni, Al, Ag/Cu, Ag/Ni, and Cu/Ni.

9. The CNT-metal particle complex composition of claim 1, further comprising: preparing a dispersion solution by dispersing the solution of operation d) in at least one selected from MEK, MIBK, acetone, cyclohexanone, a ketone solution, butoxyethyl acetate, butyl carbitol acetate (BCA), and an acetate solution; and mixing the dispersion solution with a binder.

10. A heated steering wheel comprising:
a core to maintain rigidity of the steering wheel;
a synthetic resin section formed on an outer surface of the core;
a carbon nanotube (CNT) heating a coating layer formed by coating an outer surface of the synthetic resin section with the CNT-metal particle complex composition of claim 1; and
an electrode electrically connected to the CNT heating coating layer to induce heat generation.

11. The heated steering wheel of claim 10, wherein an outer surface of the CNT heating coating layer is covered with a cover.

12. The heated steering wheel of claim 11, wherein the cover comprises any one selected from leather, fabric, and polyurethane (PU).

13. The heated steering wheel of claim 10, wherein a transfer layer is formed by a hydraulic transfer method on an outer surface of the CNT heating coating layer

14. The heated steering wheel of claim 13, wherein an external coating layer is formed on an outer surface of the transfer layer.
